(19) United States
(12) Patent Application Publication
(10) Pub. No.: US 2026/0291975 A1
(43) Pub. Date: Sep. 24, 2026

(54) VEHICLE-MOUNTED SYSTEM, SECURITY MANAGEMENT METHOD, AND SECURITY MANAGEMENT PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kazuyuki INOUE, Yokkaichi-shi, Mie (JP); Tadashi MATSUMOTO, Yokkaichi-shi, Mie (JP); Yoshitaka KIKUCHI, Yokkaichi-shi, Mie (JP); Yusuke TAKEUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/473,552

(22) PCT Filed: Mar. 21, 2024
(86) PCT No.: PCT/JP2024/011032

§ 371 Date: Oct. 8, 2025

(30) Foreign Application Priority Data
Apr. 10, 2023 (JP) 2023-063373

(51) Int. Cl. H04L 9/40

(52) U.S. Cl. CPC H04L 63/1433

(57) ABSTRACT

An in-vehicle system for installation in a vehicle includes: a plurality of functional units, including a first functional unit and a second functional unit having different configurations with respect to security; and a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.

### CROSS-REFERENCE TO RELATED APPLICATIONS

This application is the U.S. national stage of PCT/JP2024/011032 filed on Mar. 21, 2024, which claims priority of Japanese Patent Application No. JP2023-063373 filed on Apr. 10, 2023, the contents of which are incorporated herein.

### TECHNICAL FIELD

The present disclosure relates to an in-vehicle system, a security management method, and a security management program.

### BACKGROUND

JP 2020-501420A discloses the following technology. Specifically, a method for an in-vehicle network is a method in which data is transferred over at least one communication path (60) for communication in the in-vehicle network, and includes a step of performing an attack risk evaluation (86) regarding a communication path (60) over which data can be transferred in an attack, the attack risk being a risk that the communication path (60) is attacked due to making use of a security gap on the communication path (60).

Conventionally, techniques have been developed to improve security in in-vehicle networks.

There is demand for a technique that exceeds the technique described in JP 2020-501420A and can achieve excellent security functionality in an in-vehicle network.

### SUMMARY

The present disclosure has been made to solve the above-mentioned problems, and an object thereof is to provide an in-vehicle system, a security management method, and a security management program that are capable of realizing excellent security functionality in an in-vehicle network.

An in-vehicle system according to an aspect of the present disclosure is an in-vehicle system for installation in a vehicle, the in-vehicle system including: a plurality of functional units, including a first functional unit and a second functional unit having different configurations with respect to security; and a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.

Aspects of the present disclosure can be realized not only as an in-vehicle system having the above characteristic processing unit, but also as a semiconductor integrated circuit that realizes part or all of the in-vehicle system.

### Advantageous Effects

According to the present disclosure, it is possible to realize excellent security functionality in an in-vehicle network.

### BRIEF DESCRIPTION OF DRAWINGS

FIG. 1 is a diagram illustrating a configuration of a communication system according to a first embodiment of the present disclosure.

FIG. 2 is a diagram illustrating a configuration of an in-vehicle system according to the first embodiment of the present disclosure.

FIG. 3 is a diagram illustrating a configuration of an in-vehicle relay device according to the first embodiment of the present disclosure.

FIG. 4 is a diagram illustrating an example of a routing table stored by the in-vehicle relay device according to the first embodiment of the present disclosure.

FIG. 5 is a functional block diagram illustrating a configuration of the in-vehicle system according to the first embodiment of the present disclosure.

FIG. 6 is a diagram illustrating a configuration of first software used by a first core of the in-vehicle relay device according to the first embodiment of the present disclosure.

FIG. 7 is a diagram illustrating a configuration of second software used by a second core of the in-vehicle relay device according to the first embodiment of the present disclosure.

FIG. 8 is a diagram illustrating an example of the routing table after table update processing is executed by the in-vehicle relay device according to the first embodiment of the present disclosure.

FIG. 9 is a diagram illustrating an example of a management list created by list creation processing performed by the in-vehicle relay device according to the first embodiment of the present disclosure.

FIG. 10 is a flowchart defining an operation procedure performed when a core in the in-vehicle relay device according to the first embodiment of the present disclosure performs notification processing.

FIG. 11 is a flowchart defining an operation procedure performed when a relay unit in the in-vehicle relay device according to the first embodiment of the present disclosure performs table update processing and list creation processing.

FIG. 12 is a diagram illustrating an example of a sequence of processing performed by the in-vehicle relay device, an in-vehicle ECU, and a server in the communication system according to the first embodiment of the present disclosure.

FIG. 13 is a diagram illustrating an example of a sequence of processing performed by the in-vehicle relay device, the in-vehicle ECU, and the server in a modified example of the communication system according to the first embodiment of the present disclosure.

FIG. 14 is a diagram illustrating an example of a routing table stored by an in-vehicle relay device according to a second embodiment of the present disclosure.

FIG. 15 is a diagram illustrating a configuration of first software used by a first functional unit according to the second embodiment of the present disclosure.

FIG. 16 is a diagram illustrating a configuration of second software used by a second functional unit according to the second embodiment of the present disclosure.

FIG. 17 is a diagram illustrating an example of a routing table after table update processing is performed by the in-vehicle relay device according to the second embodiment of the present disclosure.

FIG. 18 is a diagram illustrating an example of a management list created by list creation processing performed by the in-vehicle relay device according to the second embodiment of the present disclosure.

FIG. 19 is a diagram illustrating an example of a sequence of processing performed by the in-vehicle relay device, the in-vehicle ECU, and the server in the communication system according to the second embodiment of the present disclosure.

### DETAILED DESCRIPTION OF PREFERRED EMBODIMENTS

First, the content of aspects of the present disclosure will be listed and described.

In a first aspect, an in-vehicle system according to an aspect of the present disclosure is an in-vehicle system for installation in a vehicle, the in-vehicle system including: a plurality of functional units, including a first functional unit and a second functional unit having different configurations with respect to security; and a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.

In this way, a plurality of access routes that have little correlation with respect to security risk are provided as access routes for access from outside the vehicle, and therefore if a security risk is discovered in one access route, it is possible to switch to another access route in which no security risk has been found, thereby making it possible to perform information communication with devices outside the vehicle while also ensuring the security of the in-vehicle network. Also, according to the configuration in which the access route for access from outside the vehicle is switched in advance while the states of the functional units are a normal state, it is possible to suppress the case where a functional unit in which a security risk has been discovered is attacked from outside the vehicle, thereby further improving security. Therefore, excellent security functionality can be realized in the in-vehicle network.

In a second aspect according to the first aspect, the control unit may be further configured to perform communication continuation processing to allow communication to continue to be performed in the vehicle by the first functional unit after reception of the risk notification from the external device.

With this configuration, even if a notification of a security risk pertaining to the first functional unit is received, various services can continue to be provided by the first functional unit in the in-vehicle network.

In a third aspect according to the second aspect, as the communication continuation processing, the control unit may allow communication to continue to be performed between the first functional unit and a functional unit other than the first functional unit and the second functional unit among the plurality of functional units.

With this configuration, even if a security risk pertaining to the first functional unit is discovered, it is possible to continue to provide a service in the in-vehicle network that uses communication between the first functional unit and a functional unit other than the first functional unit and the second functional unit.

In a fourth aspect according to the second or the third aspect, as the communication continuation processing, the control unit may allow communication to continue to be performed between the first functional unit and the second functional unit.

With this configuration, for example, even if information received from a device outside the vehicle is addressed to the first functional unit for which a security risk notification was received, the information can be transferred to the first functional unit from the second functional unit for which a security risk notification has not been received, thereby making it possible for the first functional unit to continue to execute processing that uses information from a device outside the vehicle.

In a fifth aspect according to any of the first to the fourth aspects, as the different configurations with respect to security, first software used by the first functional unit may be different from second software used by the second functional unit.

With this configuration, the functional units use different software, which is a component in which a security risk is more likely to be discovered, and therefore even if a security risk notification is received for the software in the first functional unit, it is possible to continue to execute a predetermined service in the in-vehicle network using the software in the second functional unit in which security is more ensured.

In a sixth aspect according to the fifth aspect, the first software may provide one or more functions, including a function of performing secure communication in compliance with a first communication protocol, and the second software may provide one or more functions, including a function of performing secure communication in compliance with a second communication protocol different from the first communication protocol.

With this configuration, the functional units perform secure communication using different communication protocols, which are components in which a security risk is more likely to be discovered and which are more likely to have a large influence on in-vehicle devices, and therefore even if a security risk notification is received for the communication protocol in the first functional unit, it is possible to perform secure communication using the communication protocol of the second functional unit in which security is more ensured.

In a seventh aspect according to the fifth or the sixth aspect, the first software may include a first application, and the second software may include a second application different from the first application.

With this configuration, the functional units use different applications, which are components in which a security risk is more likely to be discovered and which are more likely to have a large influence on a service used by the user of the vehicle, and therefore even if a security risk notification is received for the application of the first functional unit, it is possible to provide a predetermined function using the application of the second functional unit in which security is more ensured.

In an eighth aspect according to any of the fifth to the seventh aspects, the first software may include a first OS (Operating System), and the second software may include a second OS different from the first OS.

With this configuration, the functional units use different OSs, which are components in which a security risk is more likely to be discovered and which are more likely to have a large influence on software, and therefore even if a security risk notification is received for the OS of the first functional unit, it is possible to provide a predetermined function using the OS of the second functional unit in which security is more ensured.

In a ninth aspect, a security management method according to an aspect of the present disclosure is a security management method in an in-vehicle system that is for installation in a vehicle and includes a plurality of functional units, including a first functional unit and a second functional unit having different configurations with respect to security, the security management method including the steps of: receiving, in a case where a state of the first functional unit and a state of the second functional unit are a normal state, a risk notification regarding a security risk pertaining to the first functional unit from an external device outside the vehicle; and performing, in a case where the risk notification was received, substitution processing to stop access from the external device to the first functional unit and cause the access to be accepted by the second functional unit.

In this way, a plurality of access routes that have little correlation with respect to security risk are provided as access routes for access from outside the vehicle, and therefore if a security risk is discovered in one access route, it is possible to switch to another access route in which no security risk has been found, thereby making it possible to perform information communication with devices outside the vehicle while also ensuring the security of the in-vehicle network. Also, according to the configuration in which the access route for access from outside the vehicle is switched in advance while the states of the functional units are a normal state, it is possible to suppress the case where a functional unit in which a security risk has been discovered is attacked from outside the vehicle, thereby further improving security. Therefore, excellent security functionality can be realized in the in-vehicle network.

In a tenth aspect, a security management program according to an aspect of the present disclosure is a security management program for use in an in-vehicle system that is for installation in a vehicle and includes a plurality of functional units, including a first functional unit and a second functional unit having different configurations with respect to security, the security management program causing a computer to function as: a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.

In this way, a plurality of access routes that have little correlation with respect to security risk are provided as access routes for access from outside the vehicle, and therefore if a security risk is discovered in one access route, it is possible to switch to another access route in which no security risk has been found, thereby making it possible to perform information communication with devices outside the vehicle while also ensuring the security of the in-vehicle network. Also, according to the configuration in which the access route for access from outside the vehicle is switched in advance while the states of the functional units are a normal state, it is possible to suppress the case where a functional unit in which a security risk has been discovered is attacked from outside the vehicle, thereby further improving security. Therefore, excellent security functionality can be realized in the in-vehicle network.

Hereinafter, embodiments of the present disclosure will be described with reference to the drawings. Also, like or corresponding parts in the figures are denoted by the same reference signs, and descriptions will not be repeated for them. Also, at least portions of the embodiments described below may be combined in any manner.

### First Embodiment

### In-Vehicle System

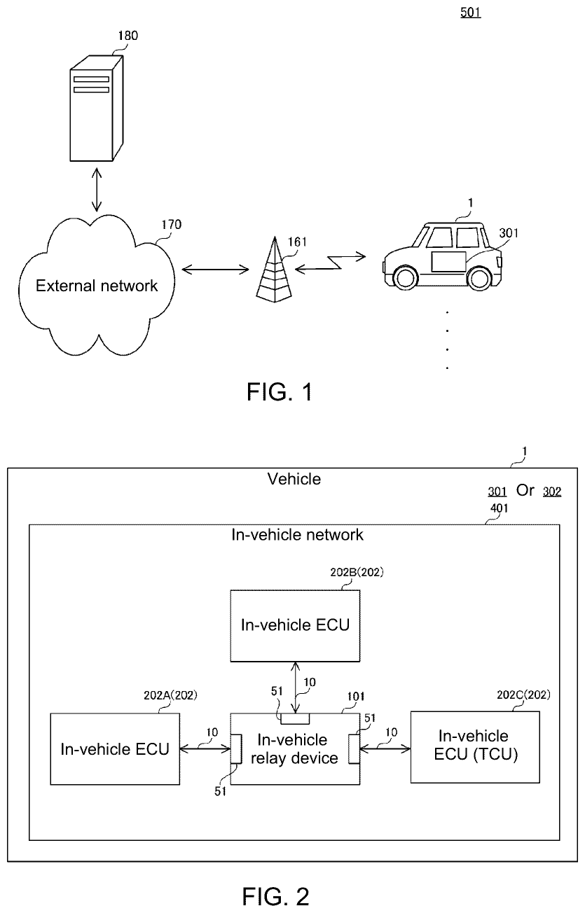

FIG. 1 is a diagram illustrating the configuration of a communication system according to a first embodiment of the present disclosure. As shown in FIG. 1, a communication system 501 includes a server 180 and one or more in-vehicle systems 301. The in-vehicle system 301 is installed in a vehicle 1. The server 180 is an example of an external device outside the vehicle 1.

FIG. 2 is a diagram illustrating the configuration of the in-vehicle system according to the first embodiment of the present disclosure. As shown in FIG. 2, the in-vehicle system 301 includes, for example, one in-vehicle relay device 101 and a plurality of in-vehicle electronic control units (ECUs) 202.

In the example shown in FIG. 2, the in-vehicle ECUs 202 of the in-vehicle system 301 include in-vehicle ECUs 202A, 202B, and 202C. The in-vehicle relay device 101 and the in-vehicle ECUs 202 configure an in-vehicle network 401.

The in-vehicle system 301 is not limited to a configuration including three in-vehicle ECUs 202, and may include one, two, or four or more in-vehicle ECUs 202. Also, the in-vehicle system 301 is not limited to a configuration including one in-vehicle relay device 101, and may include a plurality of in-vehicle relay devices 101.

The in-vehicle relay device 101 is, for example, a gateway device. The in-vehicle relay device 101 can relay data between the in-vehicle ECUs 202 connected thereto.

The in-vehicle relay device 101 and the in-vehicle ECUs 202 generate various types of information, such as information for assisting automatic driving performed by the vehicle 1 and information used for entertainment, and transmit the information to other in-vehicle ECUs 202 or the in-vehicle relay device 101.

The in-vehicle ECUs 202 are each a telematics communication unit (TCU), an engine ECU, an automatic driving ECU, a door lock ECU, or the like. Note that in addition to the in-vehicle ECUs 202 or instead of the in-vehicle ECUs 202, the in-vehicle system 301 may include in-vehicle devices such as a sensor, a navigation device, a human-machine interface, and a camera.

The in-vehicle ECUs 202 are connected to the in-vehicle relay device 101 via, for example, an Ethernet (registered trademark) cable 10.

More specifically, the in-vehicle relay device 101 includes a plurality of communication ports 51. The communication ports 51 are, for example, terminals to which Ethernet cables 10 can be connected. The in-vehicle relay device 101 and the in-vehicle ECUs 202 are each connected to the other in-vehicle ECUs 202 via the communication ports 51 and the Ethernet cables 10.

Here, the in-vehicle ECU 202C is a TCU. Hereinafter, the in-vehicle ECU 202C will also be referred to as the TCU 202C.

As shown in FIGS. 1 and 2, the TCU 202C can perform communication with the server 180. The TCU 202C can perform communication with the server 180 via a wireless base station device 161, for example.

More specifically, the TCU 202C can, for example, perform wireless communication with the wireless base station device 161 in accordance with a communication standard such as Long Term Evolution (LTE) (registered trademark) or 5G.

Specifically, when the wireless base station device 161 receives IP packets from the server 180 via an external network 170, the wireless base station device 161 transmits the received IP packets in a wireless signal to the TCU 202C.

For example, upon receiving a wireless signal including IP packets from the server 180 from the wireless base station device 161, the TCU 202C acquires the IP packets from the received wireless signal, stores the acquired IP packets in frames, and transmits the frames to the in-vehicle relay device 101.

Furthermore, upon receiving frames from the in-vehicle relay device 101, the TCU 202C acquires IP packets from the received frames, and transmits the acquired IP packets in a wireless signal to the wireless base station device 161.

Upon receiving the wireless signal from the TCU 202C, the wireless base station device 161 acquires the IP packets from the received wireless signal and transmits the acquired IP packets to the server 180 via the external network 170.

The server 180 is provided outside the vehicle 1. The server 180 manages, for example, security risks regarding various software used in the in-vehicle network 401. Here, software security risks refer to software vulnerabilities, threats to software, and the like.

Also, the in-vehicle relay device 101 is not limited to being connected to the in-vehicle ECUs 202 via the Ethernet cables 10, and may also be connected to the in-vehicle ECUs 202 via a bus conforming to a standard such as Controller Area Network (CAN), CAN with Flexible Data Rate (CAN FD), FlexRay (registered trademark), Media Oriented System Transport (MOST) (registered trademark), or Local Interconnect Network (LIN).

### In-Vehicle Relay Device

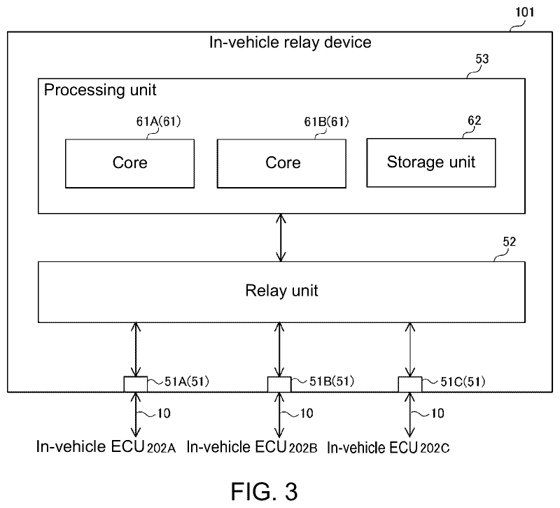

FIG. 3 is a diagram illustrating the configuration of the in-vehicle relay device according to the first embodiment of the present disclosure. As shown in FIG. 3, the in-vehicle relay device 101 includes the communication ports 51, a relay unit 52, and a processing unit 53. The processing unit 53 includes a plurality of cores 61 and a storage unit 62. The relay unit 52 and the processing unit 53 can each be realized by, for example, a processing circuit including one or more processors. Here, the each of the cores 61 corresponds to a processor. In the example shown in FIG. 3, the processing unit 53 includes cores 61A and 61B as the cores 61.

The communication ports 51 are, for example, terminals to which Ethernet cables 10 can be connected. In the example shown in FIG. 3, the in-vehicle relay device 101 includes communication ports 51A, 51B, and 51C as the communication ports 51. The communication ports 51A, 51B, and 51C are respectively connected to the in-vehicle ECUs 202A, 202B, and 202C via the Ethernet cables 10.

Note that the in-vehicle relay device 101 is not limited to a configuration including three communication ports 51, and may be a configuration including one, two, or four or more communication ports 51.

The communication ports 51 and the cores 61 are assigned corresponding port numbers. Here, the port numbers assigned to the communication ports 51A, 51B, and 51C are #1, #2, and #3, respectively, and the port numbers assigned to the cores 61A and 61B are #4 and #5, respectively.

When the relay unit 52 receives a frame from a certain in-vehicle ECU 202, the relay unit 52 transmits the received frame to the in-vehicle ECU 202 that is the destination.

Furthermore, when the relay unit 52 receives a frame addressed to one of the cores 61 of the corresponding in-vehicle relay device 101 from the in-vehicle ECU 202, the relay unit 52 outputs the frame to the destination core 61.

Furthermore, the relay unit 52 transmits the frames received from the cores 61 to the in-vehicle ECU 202 that is the destination via the communication ports 51 and the Ethernet cables 10.

More specifically, the storage unit 62 stores a routing table Tb1 that indicates the correspondence between source IP addresses included in frames, destination IP addresses included in frames, and port numbers.

Upon receiving a frame from an in-vehicle ECU 202 or a core 61, the relay unit 52 reads out the routing table Tb1 in the storage unit 62. The relay unit 52 then refers to the routing table Tb1 to identify the port numbers that correspond to the source IP address and the destination IP address contained in the frame.

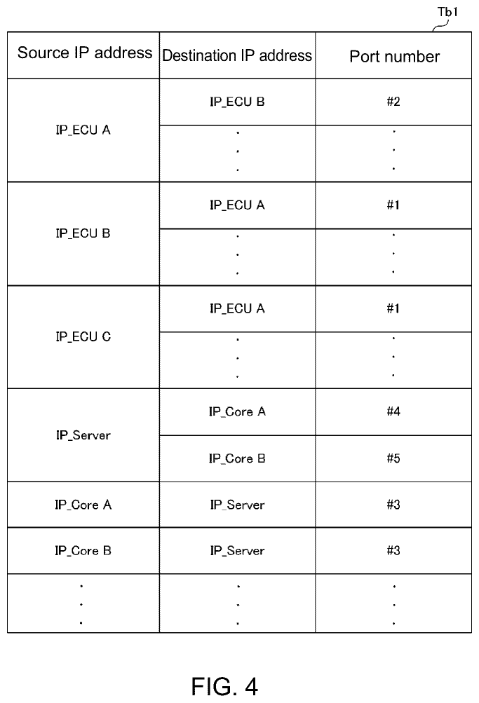

FIG. 4 is a diagram illustrating an example of the routing table stored by the in-vehicle relay device according to the first embodiment of the present disclosure.

As shown in FIG. 4, “IP_Server” indicates the IP address of the server 180, “IP_Core A” indicates the IP address of the core 61A, “IP_Core B” indicates the IP address of the core 61B, “IP_ECU A” indicates the IP address of the in-vehicle ECU 202A, “IP_ECU B” indicates the IP address of the in-vehicle ECU 202B, and “IP_ECU C” indicates the IP address of the in-vehicle ECU 202C.

Upon receiving a frame including “IP_ECU A” and “IP_ECU B” as the source IP address and the destination IP address, respectively, the relay unit 52 identifies “#2” as the port number that corresponds to the frame. Upon receiving a frame including “IP_ECU B” and “IP_ECU A” as the source IP address and the destination IP address, respectively, the relay unit 52 identifies “#1” as the port number that corresponds to the frame. Upon receiving a frame including “IP_ECU C” and “IP_ECU A” as the source IP address and the destination IP address, respectively, the relay unit 52 identifies “#1” as the port number that corresponds to the frame. Upon receiving a frame including “IP_Server” and “IP_Core A” as the source IP address and the destination IP address, respectively, the relay unit 52 identifies “#4” as the port number that corresponds to the frame. Upon receiving a frame including “IP_Server” and “IP_Core B” as the source IP address and the destination IP address, respectively, the relay unit 52 identifies “#5” as the port number that corresponds to the frame.

Upon receiving a frame including “IP_Core A” and “IP_Server” as the source IP address and the destination IP address, respectively, from the core 61A, the relay unit 52 identifies “#3” as the port number that corresponds to the frame. Upon receiving a frame including “IP_Core B” and “IP_Server” as the source IP address and the destination IP address, respectively, from the core 61B, the relay unit 52 identifies “#3” as the port number that corresponds to the frame.

Upon identifying the port number, the relay unit 52 transmits the frame from the in-vehicle ECU 202 or the frame from the core 61 to the in-vehicle ECU 202 connected to the communication port 51 that corresponds to the identified port number, or outputs the frame to the core 61 that corresponds to the port number.

When a security risk is discovered in an in-vehicle system, it takes time to develop a countermeasure to that security risk. In this case, the in-vehicle system becomes more vulnerable to attacks.

As a temporary countermeasure against a security risk, it is conceivable to discontinue provision of the function that corresponds to the part for which a security risk has been discovered in the in-vehicle system. However, if the function is an important function in the in-vehicle system, it may not be possible to stop provision of the function.

To address this, an in-vehicle system according to an embodiment of the present disclosure solves the above problem with the following configurations and operations.

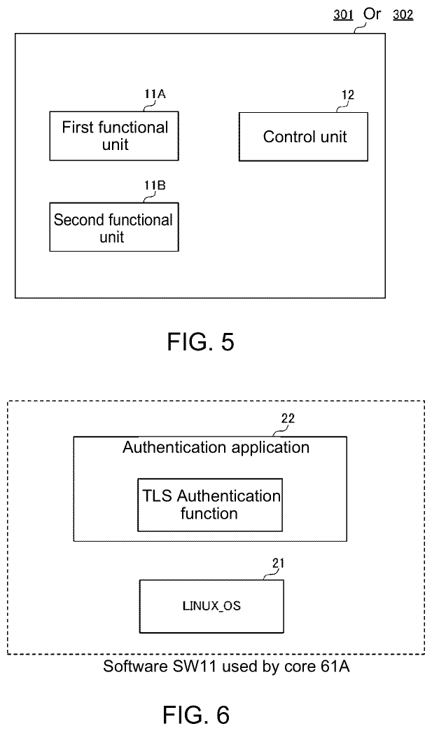

FIG. 5 is a functional block diagram illustrating the configuration of the in-vehicle system according to the first embodiment of the present disclosure. As shown in FIG. 5, the in-vehicle system 301 includes a first functional unit 11A, a second functional unit 11B, and a control unit 12. In the first embodiment of the present disclosure, the first functional unit 11A corresponds to the core 61A, and the second functional unit 11B corresponds to the core 61B. Note that the terms “first” and “second” do not imply a priority order.

As shown in FIG. 3, the core 61A and the core 61B have different configurations with respect to security. In other words, the core 61A and the core 61B have little correlation with respect to security risk. More specifically, for example, as configurations that differ in terms of security, software SW11 used by the core 61A is different from software SW12 used by the core 61B. The software SW11 is an example of first software, and the software SW12 is an example of second software.

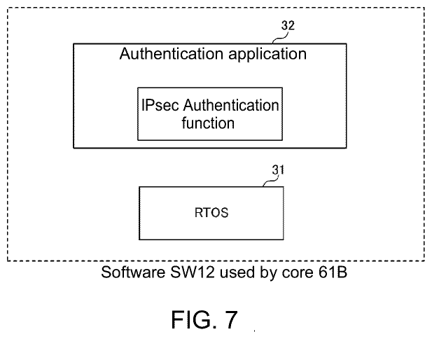

FIG. 6 is a diagram illustrating the configuration of the first software used by the first core of the in-vehicle relay device according to the first embodiment of the present disclosure. FIG. 7 is a diagram illustrating the configuration of the second software used by the second core of the in-vehicle relay device according to the first embodiment of the present disclosure.

As shown in FIGS. 6 and 7, different operating systems (OSs) are installed in the core 61A and the core 61B, for example.

More specifically, for example, the software SW11 includes a LINUX_OS (LINUX is a registered trademark) 21. The LINUX_OS 21 is an example of a first OS. Note that the software SW11 may include a general-purpose OS other than the LINUX_OS 21.

For example, the software SW12 includes an OS different from the LINUX_OS 21. Specifically, for example, the software SW12 includes a real time operating system (RTOS) 22. The RTOS 31 is an example of a second OS. Note that as long as the OS is different from the OS included in the software SW1, the software SW12 may include an OS other than the RTOS 31.

Moreover, different applications are installed in the core 61A and the core 61B, for example.

More specifically, for example, the software SW11 includes an authentication application 22, and the software SW12 includes an authentication application 32 that is different from the authentication application 22. The authentication application 22 and the authentication application 32 are examples of a first application and a second application, respectively.

For example, the function provided by the authentication application 22 included in the software SW11 includes a TLS authentication function that performs secure communication in compliance with the Transport Layer Security (TLS) standard. TLS is an example of a first communication protocol.

As shown in FIGS. 1 and 3, specifically, for example, when the in-vehicle relay device 101 is started up, the corresponding core 61A transmits authentication request information R11 indicating a request for authentication to the server 180 via the relay unit 52 and the TCU 202C, in accordance with a procedure compliant with TLS.

Specifically, for example, the core 61A creates an IP packet that includes the authentication request information R11 and includes its own IP address as the source IP address and the IP address of the server 180 as the destination IP address. The core 61A then transmits the created IP packet to the server 180 via the relay unit 52 and the TCU 202C.

For example, the server 180 receives the authentication request information R11 from the in-vehicle relay device 101 via the TCU 202C, and performs authentication processing for the core 61A in accordance with a procedure compliant with TLS.

If authentication of the core 61A is successful in the authentication processing performed on the core 61A, the server 180 creates an IP packet that includes authentication success information R12, which indicates successful authentication, and includes its own IP address as the source IP address and the IP address of the core 61A as the destination IP address. The server 180 then transmits the created IP packet to the in-vehicle relay device 101 via the TCU 202C.

The core 61A of the in-vehicle relay device 101 receives the IP packet that includes the authentication success information R12 from the server 180 via the TCU 202C and the relay unit 52, and starts communication with the server 180.

On the other hand, if authentication of the core 61A fails, the server 180 creates an IP packet that includes authentication failure information R13, which indicates the authentication failure, and includes its own IP address as the source IP address and the IP address of the core 61A as the destination IP address. The server 180 then transmits the created IP packet to the in-vehicle relay device 101 via the TCU 202C.

The core 61A of the in-vehicle relay device 101 receives the IP packet that includes the authentication failure information R13 from the server 180 via the TCU 202C and the relay unit 52, and determines that communication with the server 180 is not possible.

For example, the function provided by the authentication application 32 included in the software SW12 includes an IPsec (Security Architecture for Internet Protocol) authentication function for performing secure communication in accordance with the IPsec standard. IPsec is an example of a second communication protocol.

More specifically, when the in-vehicle relay device 101 is started up, the corresponding core 61B transmits authentication request information R21 indicating a request for authentication to the server 180 via the relay unit 52 and the TCU 202C, in accordance with a procedure compliant with IPsec.

Specifically, for example, the core 61B creates an IP packet that includes the authentication request information R21 and includes its own IP address as the source IP address and the IP address of the server 180 as the destination IP address. The core 61B then transmits the created IP packet to the server 180 via the relay unit 52 and the TCU 202C.

For example, the server 180 receives the authentication request information R21 from the in-vehicle relay device 101 via the TCU 202C, and performs authentication processing for the core 61B in accordance with a procedure compliant with IPsec.

If authentication of the core 61B is successful in the authentication processing performed on the core 61B, the server 180 creates an IP packet that includes authentication success information R22, which indicates successful authentication, and includes its own IP address as the source IP address and the IP address of the core 61B as the destination IP address. The server 180 then transmits the created IP packet to the in-vehicle relay device 101 via the TCU 202C.

The core 61B of the in-vehicle relay device 101 receives the IP packet that includes the authentication success information R22 from the server 180 via the TCU 202C and the relay unit 52, and starts communication with the server 180.

On the other hand, if authentication of the core 61B fails, the server 180 creates an IP packet that includes authentication failure information R23, which indicates the authentication failure, and includes its own IP address as the source IP address and the IP address of the core 61B as the destination IP address. The server 180 then transmits the created IP packet to the in-vehicle relay device 101 via the TCU 202C.

The core 61B the in-vehicle relay device 101 receives the IP packet that includes the authentication failure information R23 from the server 180 via the TCU 202C and the relay unit 52, and determines that communication with the server 180 is not possible.

Note that the authentication application 22 may have a function for performing secure communication in accordance with a communication protocol other than TLS. Furthermore, as long as the communication protocol is different from the communication protocol used in the authentication application 22, the authentication application 32 may have a function for performing secure communication in accordance with a communication protocol other than IPsec.

### Substitution Processing

Referring again to FIGS. 3 and 5, in a case where the state of the core 61A and the state of the core 61B are a normal state and a risk notification regarding a security risk pertaining to the core 61A is received from the server 180, the control unit 12 performs substitution processing to stop access from the server 180 to the core 61A and cause access from the server 180 to be accepted by the core 61B. In the first embodiment of the present disclosure, the control unit 12 is realized by the relay unit 52 and the core 61B shown in FIG. 3.

More specifically, for example, if a security risk is discovered in at least either one of the LINUX_OS 21 and the authentication application 22 in the core 61A, the server 180 creates an IP packet that includes a risk notification indicating that a security risk has been discovered in the core 61A, and also includes its own IP address as the source IP address and the IP address of the core 61B as the destination IP address. The server 180 then transmits the created IP packet to the TCU 202C via the wireless base station device 161.

The TCU 202C receives the IP packet that includes the risk notification from the server 180, stores the IP packet in a frame (hereinafter also referred to as a “vulnerability notification frame”), and transmits the frame to the in-vehicle relay device 101.

The core 61B of the in-vehicle relay device 101 receives the vulnerability notification frame from the TCU 202C via the relay unit 52, and performs notification processing for outputting, to the relay unit 52, an update notification indicating a request to update the routing table Tb1.

More specifically, for example, the storage unit 62 stores an address table Tb 10 indicating the correspondence between the cores 61 and IP addresses.

If the core 61B is exchanging information with the in-vehicle ECUs 202 or the core 61A and receives a vulnerability notification frame from the TCU 202C via the relay unit 52, the core 61B refers to the address table Tb10 in the storage unit 62 and checks the IP address of the core 61A.

In the case of confirming the IP address of the core 61A, in the notification processing, the core 61B outputs, to the relay unit 52, an update notification indicating a request to update the routing table Tb1, and table update information including the IP address of the server 180 included in the vulnerability notification frame and the confirmed IP address of the core 61A. The core 61B may output the table update information to the relay unit 52 in a standby state in which information is not being exchanged with the in-vehicle ECUs 202 or the core 61A.

The relay unit 52 receives the table update information from the core 61B, and performs table update processing to update the routing table Tb1.

More specifically, in the table update processing, the relay unit 52 performs processing for changing the relay destination of a frame whose source IP address is the IP address of the server 180 and whose destination IP address is the IP address of the core 61A in the routing table Tb1. Specifically, for example, the relay unit 52 changes the relay destination of the frame from the core 61A to the core 61B. In other words, the relay unit 52 causes access from the server 180 to be accepted by the core 61B instead of the core 61A.

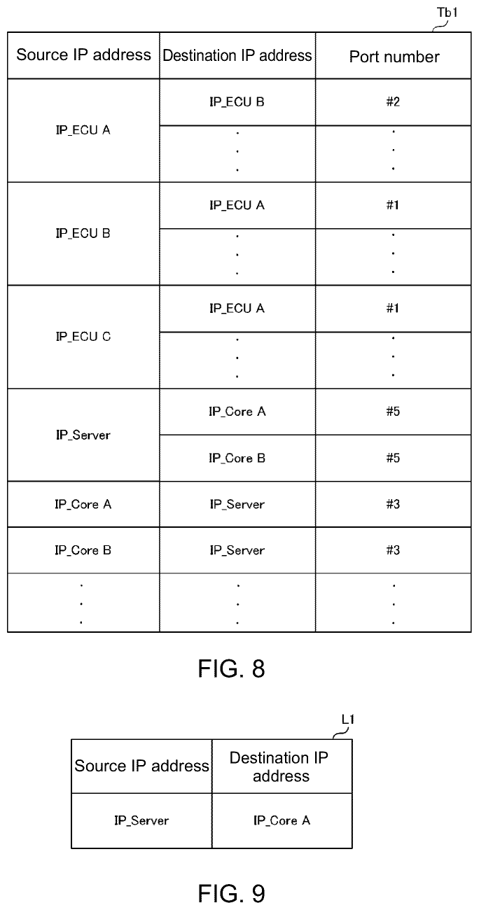

FIG. 8 is a diagram illustrating an example of the routing table after table update processing is executed by the in-vehicle relay device according to the first embodiment of the present disclosure.

As shown in FIGS. 3 and 8, specifically, for example, upon receiving table update information from the core 61B, the relay unit 52 reads out the routing table Tb1 in the storage unit 62. Then, in the routing table Tb1, the relay unit 52 identifies a frame whose source IP address is the IP address of the server 180 included in the table update information and whose destination IP address is the IP address of the core 61A, and changes the port number corresponding to the identified frame from “#4” to “#5”.

Also, for example, upon receiving table update information from the core 61B, the relay unit 52 performs list creation processing to create a management list L1 that indicates the correspondence between the source IP address included in the frame whose relay destination is changed (hereinafter also referred to as the “changed relay destination frame”) and the destination IP address included in the changed relay destination frame.

FIG. 9 is a diagram illustrating an example of the management list created by list creation processing performed by the in-vehicle relay device according to the first embodiment of the present disclosure.

As shown in FIG. 9, upon receiving table update information from the core 61B, the relay unit 52 creates the management list L1 indicating a relay stop frame whose source IP address is the IP address “IP_Server” of the server 180 included in the table update information and whose destination IP address is the IP address “IP_Core A” of the core 61A included in the table update information. The relay unit 52 then stores the created management list L1 in the storage unit 62.

### Communication Continuation Processing

Referring again to FIG. 3, for example, the relay unit 52 further performs communication continuation processing for allowing communication to continue to be performed in the vehicle 1 by the core 61A after receiving a risk notification from the server 180.

More specifically, for example, as the communication continuation processing, the relay unit 52 allows communication between the core 61A and the core 61B to continue to be performed.

Specifically, for example, the relay unit 52 receives a risk notification from the server 180 via the TCU 202C and performs table update processing and list creation processing, and then upon receiving a frame from an in-vehicle ECU 202, reads out the routing table Tb1 and the management list L1 in the storage unit 62. The relay unit 52 then refers to the management list L1 and checks whether or not the frame received from the in-vehicle ECU 202 is a relay stop frame.

If the frame received from the in-vehicle ECU 202 is a relay stop frame, the relay unit 52 stores, in the payload of the frame, identification information indicating that the frame is addressed to the core 61A. The relay unit 52 then refers to the routing table Tb1 and outputs the frame storing the identification information to the core 61B.

After outputting the table update information to the relay unit 52, when the core 61B receives a frame from the relay unit 52, the core 61B checks whether or not identification information is stored in the payload of the frame.

If identification information is stored in the payload of the frame received from the relay unit 52, the core 61B performs transfer processing for outputting the frame to the core 61A. The core 61A receives the frame from the core 61B and performs predetermined processing based on various information included in the frame.

On the other hand, if identification information is not stored in the payload of the frame received from the relay unit 52, the core 61B determines that transfer processing does not need to be performed. The core 61B then performs predetermined processing based on various information included in the frame.

Also, for example, as the communication continuation processing, the relay unit 52 allows communication between the core 61A and the in-vehicle ECUs 202 to continue to be performed.

More specifically, for example, after receiving a risk notification from the server 180, if a frame received from an in-vehicle ECU 202 is not a relay stop frame, the relay unit 52 refers to the routing table Tb1 and outputs the frame to the in-vehicle ECU 202 or the core 61 that is the destination.

Specifically, for example, after receiving a risk notification from the server 180, when the relay unit 52 receives a frame addressed to the core 61A from an in-vehicle ECU 202, the relay unit 52 outputs the frame to the core 61A that is the destination.

Furthermore, for example, after receiving a risk notification from the server 180, when the relay unit 52 receives a frame addressed to an in-vehicle ECU 202 from the core 61A, the relay unit 52 transmits the frame to the in-vehicle ECU 202 that is the destination.

### Transmission of Information From Core 61A to Server 180

Also, for example, after receiving a risk notification from the server 180, the relay unit 52 allows the transmission of information from the core 61A to the server 180 to continue.

More specifically, for example, after receiving a risk notification from the server 180, when the relay unit 52 receives a frame addressed to the server 180 from the core 61A, the relay unit 52 transmits the frame to the server 180 that is the destination via the TCU 202C.

Note that after receiving a risk notification from the server 180, the relay unit 52 may stop the transmission of information from the core 61A to the server 180.

### Operation Flow

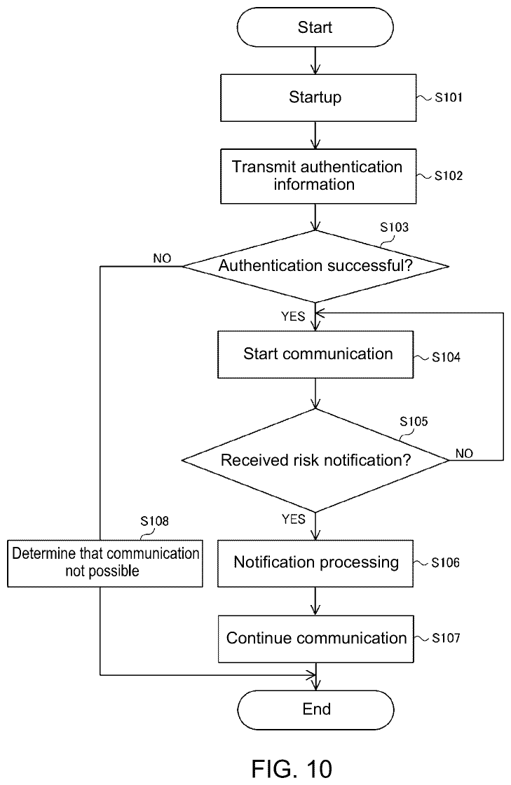

FIG. 10 is a flowchart defining an operation procedure performed when a core in the in-vehicle relay device according to the first embodiment of the present disclosure performs notification processing. FIG. 10 shows an operation procedure performed when the core 61B of the in-vehicle relay device 101 performs notification processing.

As shown in FIG. 10, when the in-vehicle relay device 101 of the core 61B is started up (step S101), the core 61B transmits the authentication request information R21 for requesting authentication by the server 180, to the server 180 via the TCU 202C (step S102).

Next, the core 61B receives the authentication success information R22 indicating successful authentication from the server 180 (YES in step S103), and starts communication with the server 180 (step S104).

Next, upon receiving a risk notification regarding a security risk pertaining to the core 61A (YES in step S105), the core 61B performs notification processing to output, to the relay unit 21, an update notification indicating a request to update the routing table Tb1, and table update information including the IP address of the server 180 indicated in the risk notification and the IP address of the core 61A (step S106).

The core 61B then continues to perform communication with the core 61A. For example, as described above, upon receiving a frame storing the above-described identification information from the relay unit 52, the core 61B outputs the frame to the core 61A (step S107).

On the other hand, upon receiving the authentication failure information R23 indicating authentication failure from the server 180 (NO in step S103), the core 61B determines that communication with the server 180 is not possible (step S108).

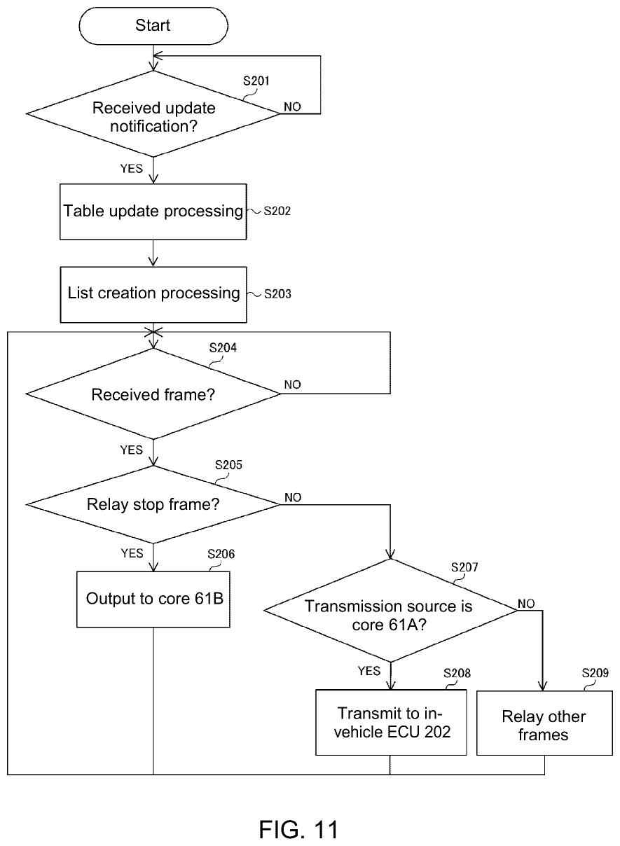

FIG. 11 is a flowchart defining an operation procedure performed when the relay unit in the in-vehicle relay device according to the first embodiment of the present disclosure performs table update processing and list creation processing.

As shown in FIG. 11, first, the relay unit 52 waits for table update information from the core 61B (NO in step S201), and upon receiving table update information from the core 61B (YES in step S201), performs table update processing to update the routing table Tb1. For example, as described above, in the routing table Tb1, the relay unit 52 identifies a frame whose source IP address is the IP address of the server 180 included in the table update information received from the core 61B and whose destination IP address is the IP address of the core 61A included in the table update information, and changes the port number corresponding to the identified frame to the port number that corresponds to the core 61B (step S202).

Next, the relay unit 52 performs list creation processing to create the management list L1. For example, as described above, the relay unit 52 creates the management list L1 indicating the correspondence between the source IP address included in the changed relay destination frame and the destination IP address included in the changed relay destination frame (step S203). Note that steps S202 and S203 may be executed in reverse order, or may be executed in parallel.

Next, the relay unit 52 waits for reception of a frame (NO in step S204), and upon receiving a frame (YES in step S204), performs relay processing.

More specifically, if the received frame is a relay stop frame (YES in step S205), the relay unit 52 outputs the frame to the core 61B. For example, as described above, the relay unit 52 stores, in the payload of the frame, identification information indicating that the frame is addressed to the core 61A, and outputs the frame to the core 61B (step S206).

Furthermore, if the transmission source of the received frame is the core 61A (NO in step S205 and YES in step S207), the relay unit 52 transmits the frame to the in-vehicle ECU 202 that is the destination (step S208).

On the other hand, if another frame is received (NO in step S205 and NO in step S207), the relay unit 52 performs relay processing for that frame (step S209).

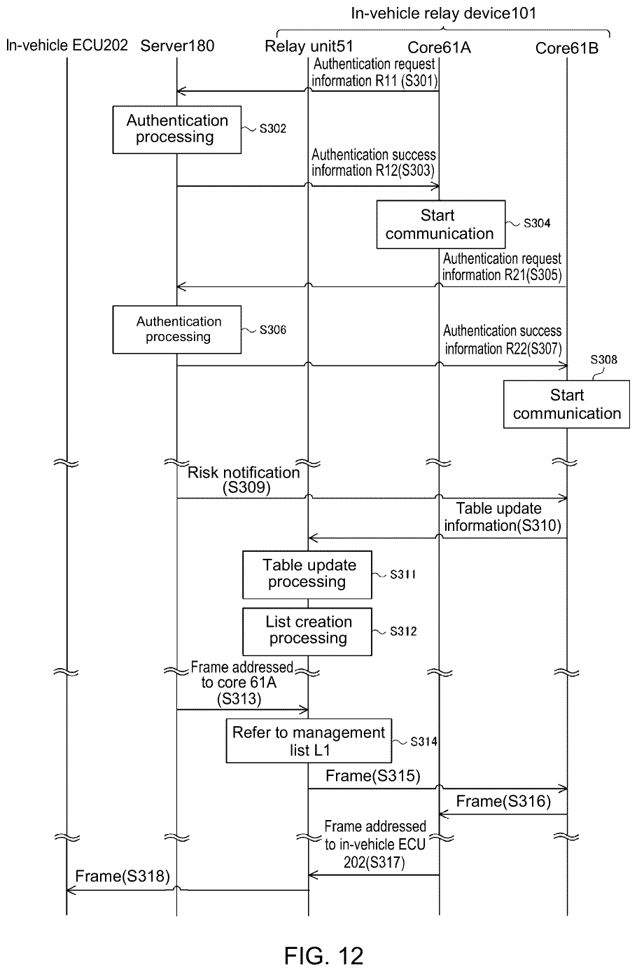

FIG. 12 is a diagram illustrating an example of a sequence of processing performed by the in-vehicle relay device, an in-vehicle ECU, and the server in the communication system according to the first embodiment of the present disclosure.

As shown in FIG. 12, first, the core 61A transmits the authentication request information R11 indicating a request for authentication and indicating its own IP address, to the server 180 via the relay unit 52 and the TCU 202C (step S301).

Next, the server 180 receives the authentication request information R11 from the in-vehicle relay device 101 via the TCU 202C, and performs authentication processing for the core 61A (step S302).

Next, if authentication of the core 61A is successful, the server 180 transmits an IP packet that includes the authentication success information R12 indicating successful authentication and includes its own IP address as the source IP address and the IP address of the core 61A as the destination IP address, to the in-vehicle relay device 101 via the TCU 202C (step S303).

Next, the core 61A of the in-vehicle relay device 101 receives the IP packet that includes the authentication success information R12 from the server 180 via the TCU 202C and the relay unit 52, and starts communication with the server 180 (step S304).

Next, the core 61B transmits the authentication request information R21 indicating a request for authentication and indicating its own IP address to the server 180 via the relay unit 52 and the TCU 202C (step S305).

Next, the server 180 receives the authentication request information R21 from the in-vehicle relay device 101 via the TCU 202C, and performs authentication processing for the core 61B (step S306).

Next, if authentication of the core 61B is successful, the server 180 transmits an IP packet that includes the authentication success information R22 indicating successful authentication and includes its own IP address as the source IP address and the IP address of the core 61B as the destination IP address, to the in-vehicle relay device 101 via the TCU 202C (step S307).

Next, the core 61B of the in-vehicle relay device 101 receives the IP packet that includes the authentication success information R22 from the server 180 via the TCU 202C and the relay unit 52, and starts communication with the server 180 (step S308).

Next, the server 180 transmits a risk notification regarding a security risk pertaining to the core 61A to the in-vehicle relay device 101 via the TCU 202C. For example, as described above, the server 180 transmits an IP packet that includes the risk notification and includes its own IP address as the source IP address and the IP address of the core 61B as the destination IP address, to the in-vehicle relay device 101 via the TCU 202C (step S309).

Next, the core 61B of the in-vehicle relay device 101 outputs, to the relay unit 52, an update notification indicating a request to update the routing table Tb1, and table update information that includes the IP address of the server 180 indicated in the risk notification and the IP address of the core 61A (step S310).

Next, the relay unit 52 performs table update processing to update the routing table Tb1. For example, as described above, in the routing table Tb1, the relay unit 52 identifies a frame whose source IP address is the IP address of the server 180 included in the table update information received from the core 61B and whose destination IP address is the IP address of the core 61A included in the table update information, and changes the port number corresponding to the identified frame to the port number that corresponds to the core 61B (step S311).

Next, the relay unit 52 performs list creation processing to create the management list L1. For example, as described above, the relay unit 52 creates the management list L1 indicating the correspondence between the source IP address included in the changed relay destination frame and the destination IP address included in the changed relay destination frame (step S312). Note that steps S311 and S312 may be executed in reverse order, or may be executed in parallel.

Next, the server 180 transmits the frame addressed to the core 61A to the in-vehicle relay device 101 via the TCU 202C (step S313).

Next, in the in-vehicle relay device 101, the relay unit 52 refers to the management list L1 in the storage unit 62 and confirms that the destination IP address included in the frame received from the server 180 is registered in the management list L1 (step S314).

Next, the relay unit 52 stores, in the payload of the frame received from the server 180, identification information indicating that the frame is addressed to the core 61A, and outputs the frame to the core 61B (step S315).

Next, upon receiving the frame storing the identification information from the relay unit 52, the core 61B outputs the frame to the core 61A (step S316).

Next, the core 61A outputs a frame addressed to a certain in-vehicle ECU 202 to the relay unit 52 (step S317).

Next, the relay unit 52 transmits the frame received from the core 61A to the in-vehicle ECU 202 that is the destination (step S318).

### Modified Examples

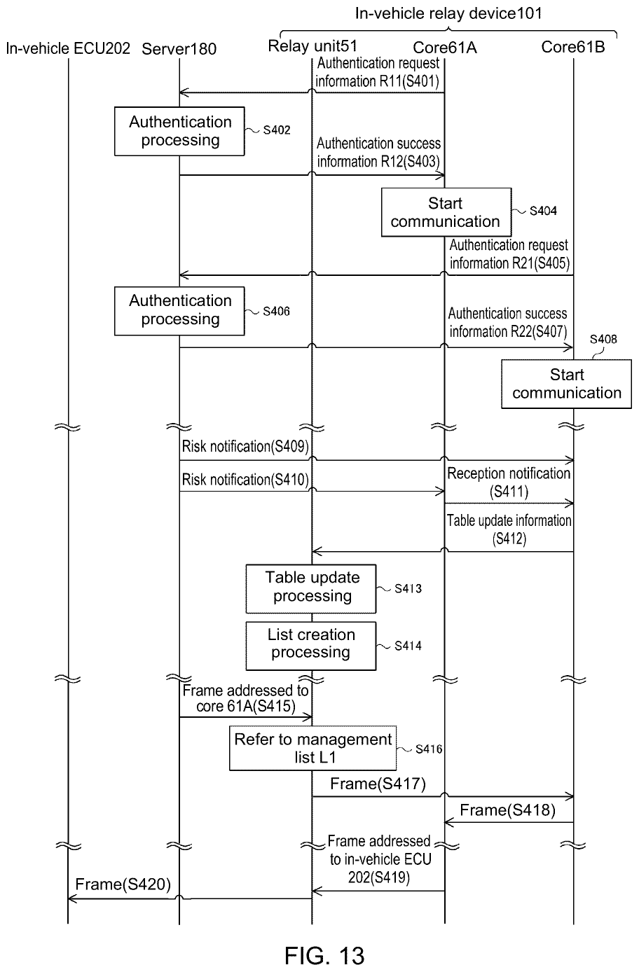

FIG. 13 is a diagram illustrating an example of a sequence of processing performed by the in-vehicle relay device, an in-vehicle ECU, and the server in a modified example of the communication system according to the first embodiment of the present disclosure.

The processing of steps S401 to S409 shown in FIG. 13 is similar to the processing of steps S301 to S309 shown in FIG. 12.

The server 180 then transmits a risk notification regarding a security risk pertaining to the core 61A, to both the core 61A and the core 61B. More specifically, the server 180 transmits an IP packet that includes the risk notification and includes its own IP address as the source IP address and the IP address of the core 61A as the destination IP address, to the in-vehicle relay device 101 via the TCU 202C (step S 410).

Next, in the in-vehicle relay device 101, the core 61A receives the risk notification from the server 180 via the TCU 202C and the relay unit 52, and outputs a reception notification indicating that the risk notification has been received to the core 61B (step S 411).

Next, the core 61B receives the risk notification from the server 180 and also receives the reception notification from the core 61A, and outputs, to the relay unit 52, an update notification indicating a request to update the routing table Tb1, and table update information that includes the IP address of the server 180 indicated in the risk notification and the IP address of the core 61A (step S 412).

The processing of steps S413 to S420 is similar to the processing of steps S311 to S318 shown in FIG. 12.

Note that in the in-vehicle relay device 101 according to the first embodiment of the present disclosure, the processing unit 53 includes two cores 61, but the present disclosure is not limited to this. The processing unit 53 may include three or more cores 61. In this case, after receiving a risk notification pertaining to one of the cores 61 from the server 180, the relay unit 52 updates the routing table Tb1 and the management list L1 every time a new risk notification pertaining to one of the cores 61 is received from the server 180.

Furthermore, in the in-vehicle relay device 101 according to the first embodiment of the present disclosure, the routing table Tb1 in the storage unit 62 is not limited to a configuration indicating the correspondence between source IP addresses included in frames, destination IP addresses included in frames, and port numbers, and may also be configured to indicate the correspondence between source MAC (Media Access Control) addresses included in frames, destination MAC addresses included in frames, and port numbers. In this case, if a security risk is discovered in the core 61A, the server 180 transmits an IP packet that includes a risk notification and includes its own MAC address as the source MAC address and the MAC address of the core 61A as the destination MAC address, to the in-vehicle relay device 101 via TCU 202C.

### Second Embodiment

In the above-described first embodiment of the present disclosure, the core 61A and the core 61B have different configurations with respect to security, and the control unit 12 that performs substitution processing is realized by the relay unit 52 and the core 61B. In contrast, in a second embodiment of the present disclosure, the in-vehicle ECU 202A and the in-vehicle ECU 202B have different configurations with respect to security, and the control unit that performs substitution processing is realized by the in-vehicle relay device 101 and the in-vehicle ECU 202B. Matter other than that described below is similar to that of the communication system 501 according to the first embodiment.

FIG. 2 also shows the configuration of an in-vehicle system according to the second embodiment of the present disclosure. As shown in FIG. 2, an in-vehicle system 302 includes the in-vehicle ECUs 202A, 202B, and 202C as the in-vehicle ECUs 202, and the in-vehicle relay device 101. Note that the in-vehicle system 302 is not limited to a configuration including three in-vehicle ECUs 202, and may include two or four or more in-vehicle ECUs 202.

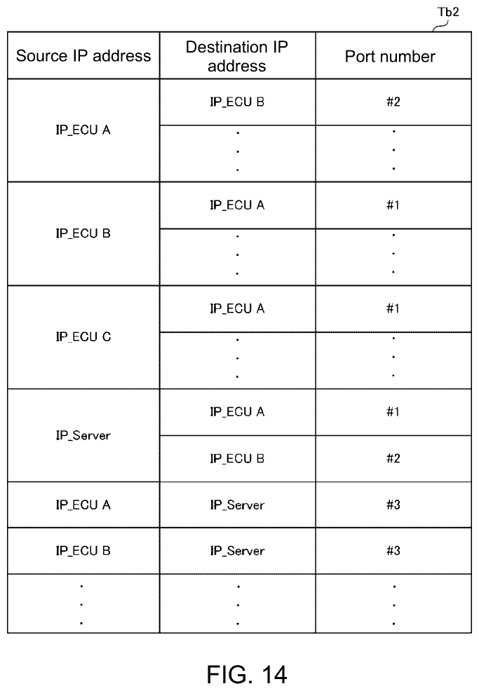

FIG. 14 is a diagram illustrating an example of a routing table stored by the in-vehicle relay device according to the second embodiment of the present disclosure.

As shown in FIGS. 2 and 14, the storage unit 62 of the in-vehicle relay device 101 stores a routing table Tb2 used in relay processing.

Using the routing table Tb2, if a frame including “IP_Server” as the source IP address and “IP_ECU A” as the destination IP address is received, the in-vehicle relay device 101 identifies “#1” as the port number that corresponds to the frame. If a frame including “IP_Server” as the source IP address and “IP_ECU B” as the destination IP address is received, the in-vehicle relay device 101 identifies “#2” as the port number that corresponds to the frame. If a frame including “IP_ECU A” as the source IP address and “IP_Server” as the destination IP address is received, the in-vehicle relay device 101 identifies “#3” as the port number that corresponds to the frame. If a frame including “IP_ECU B” as the source IP address and “IP_Server” as the destination IP address is received, the in-vehicle relay device 101 identifies “#3” as the port number that corresponds to the frame.

FIG. 5 also shows functional blocks of the in-vehicle system according to the second embodiment of the present disclosure. As shown in FIG. 5, in the second embodiment of the present disclosure, the first functional unit 11A corresponds to the in-vehicle ECU 202A, and the second functional unit 11B corresponds to the in-vehicle ECU 202B.

The in-vehicle ECU 202A and the in-vehicle ECU 202B have different configurations with respect to security. In other words, the in-vehicle ECU 202A and the in-vehicle ECU 202B have little correlation with respect to security risk. More specifically, for example, regarding configurations that differ in terms of security, software SW21 used by the in-vehicle ECU 202A is different from software SW22 used by the in-vehicle ECU 202B. In other words, the software SW21 installed in the in-vehicle ECU 202A is different from the software installed in the in-vehicle ECU 202B.

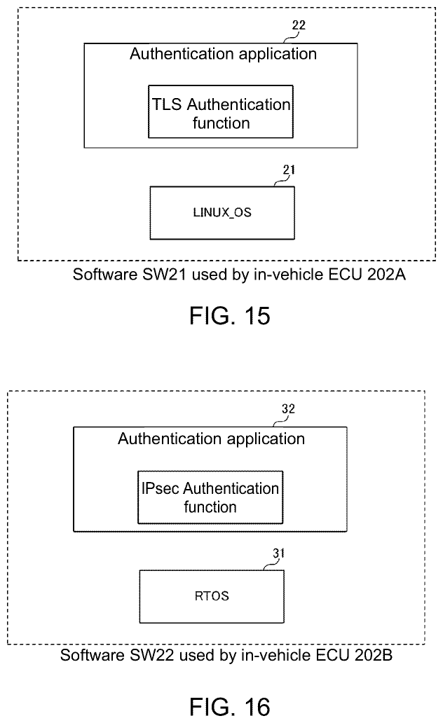

FIG. 15 is a diagram illustrating the configuration of first software used by the first functional unit according to the second embodiment of the present disclosure. FIG. 16 is a diagram illustrating the configuration of second software used by the second functional unit according to the second embodiment of the present disclosure.

As shown in FIGS. 15 and 16, different OSs are installed in the in-vehicle ECU 202A and the in-vehicle ECU 202B, for example.

More specifically, for example, the software SW21 includes the LINUX_OS 21. Note that the software SW21 may include a general-purpose OS other than the LINUX OS 21.

For example, the software SW22 includes an OS different from the LINUX_OS 21. Specifically, for example, the software SW22 includes an RTOS 31. Note that as long as the OS is different from the OS included in the software SW21, the software SW22 may include an OS other than the RTOS 31.

Furthermore, different applications are installed in the in-vehicle ECU 202A and the in-vehicle ECU 202B, for example.

More specifically, for example, the software SW21 includes the authentication application 22, and the software SW22 includes the authentication application 32 that is different from the authentication application 22.

For example, the function provided by the authentication application 22 included in the software SW21 includes a TLS authentication function that performs secure communication in compliance with the TLS standard.

Specifically, for example, after being started up, the in-vehicle ECU 202A transmits the authentication request information R31 indicating a request for authentication and indicating its own IP address to the server 180 via the in-vehicle relay device 101 and the TCU 202C in accordance with a procedure compliant with TLS.

For example, the server 180 receives the authentication request information R31 from the in-vehicle ECU 202A via the in-vehicle relay device 101 and the TCU 202C, and performs authentication processing for the in-vehicle ECU 202A in accordance with a procedure compliant with TLS.

If authentication of the in-vehicle ECU 202A is successful in the authentication processing performed on the in-vehicle ECU 202A, the server 180 creates an IP packet that includes the authentication success information R32, which indicates successful authentication, and includes the IP address of the server 180 as the source IP address and the IP address of the in-vehicle ECU 202A as the destination IP address. The server 180 then transmits the created IP packet to the in-vehicle ECU 202A via the TCU 202C and the in-vehicle relay device 101.

The in-vehicle ECU 202A receives the IP packet that includes the authentication success information R32 from the server 180 via the TCU 202C and the in-vehicle relay device 101, and starts communication with the server 180.

On the other hand, if authentication of the in-vehicle ECU 202A fails, the server 180 creates an IP packet that includes authentication failure information R33, which indicates the authentication failure, and includes the IP address of the server 180 as the source IP address and the IP address of the in-vehicle ECU 202A as the destination IP address. The server 180 then transmits the created IP packet to the in-vehicle ECU 202A via the TCU 202C and the in-vehicle relay device 101.

The in-vehicle ECU 202A receives the IP packet that includes the authentication failure information R33 from the server 180 via the TCU 202C and the in-vehicle relay device 101, and determines that communication with the server 180 is not possible.

For example, the function provided by the authentication application 32 included in the software SW22 includes an IPsec authentication function for performing secure communication in accordance with the IPsec standard.

More specifically, for example, after being started up, the in-vehicle ECU 202B transmits authentication request information R41 indicating an authentication request and indicating its own IP address to the server 180 via the in-vehicle relay device 101 and the TCU 202C in accordance with a procedure compliant with IPsec.

For example, the server 180 receives the authentication request information R41 from the in-vehicle ECU 202B via the TCU 202C, and performs authentication processing for the in-vehicle ECU 202B in accordance with a procedure compliant with IPsec.

If authentication of the in-vehicle ECU 202B is successful in the authentication processing performed on the in-vehicle ECU 202B, the server 180 creates an IP packet that includes the authentication success information R42, which indicates successful authentication, and includes the IP address of the server 180 as the source IP address and the IP address of the in-vehicle ECU 202B as the destination IP address. The server 180 then transmits the created IP packet to the in-vehicle ECU 202B via the TCU 202C and the in-vehicle relay device 101.

The in-vehicle ECU 202B receives the IP packet that includes the authentication success information R42 from the server 180 via the TCU 202C and the in-vehicle relay device 101, and starts communication with the server 180.

On the other hand, if authentication of the in-vehicle ECU 202B fails, the server 180 generates authentication failure information R43 indicating the authentication failure and indicating the IP address of the in-vehicle ECU 202B as the destination IP address, and transmits the generated authentication failure information R43 to the in-vehicle ECU 202B via the TCU 202C and the in-vehicle relay device 101.

The in-vehicle ECU 202B receives the IP packet that includes the authentication failure information R43 from the server 180 via the TCU 202C and the in-vehicle relay device 101, and determines that communication with the server 180 is not possible.

### Substitution Processing

Referring again to FIG. 5, in a case where the state of the in-vehicle ECU 202A and the state of the in-vehicle ECU 202B are a normal state and a risk notification regarding a security risk pertaining to the in-vehicle ECU 202A is received from the server 180, the control unit 12 performs substitution processing to stop access from the server 180 to the in-vehicle ECU 202A and cause access from the server 180 to be accepted by the in-vehicle ECU 202B. In the first embodiment of the present disclosure, the control unit 12 is realized by the in-vehicle relay device 101 and the in-vehicle ECU 202B shown in FIG. 2.

More specifically, for example, when a security risk is discovered in at least either one of the LINUX_OS 21 and the authentication application 22 in the in-vehicle ECU 202A, the server 180 transmits an IP packet that includes a risk notification indicating that a security risk has been discovered in the in-vehicle ECU 202A, and includes its own IP address as the source IP address and the IP address of the in-vehicle ECU 202B as the destination IP address, to the in-vehicle ECU 202B via the TCU 202C and the in-vehicle relay device 101.

The in-vehicle ECU 202B receives the risk notification from the server 180 via the TCU 202C and the in-vehicle relay device 101, and performs notification processing for transmitting, to the in-vehicle relay device 101, an update notification indicating a request to update the routing table Tb2.

Specifically, for example, a storage unit (not shown) in the in-vehicle ECU 202B stores an address table Tb20 indicating the IP address of the in-vehicle ECU 202A.

For example, if the in-vehicle ECU 202B is exchanging information with another device and receives a risk notification from the server 180 via the TCU 202C and the in-vehicle relay device 101, the in-vehicle ECU 202B refers to the address table Tb20 in its own storage unit and checks the IP address of the in-vehicle ECU 202A.

In the case of confirming the IP address of the in-vehicle ECU 202A, in the notification processing, the in-vehicle ECU 202B creates a table update frame including an update notification indicating a request to update the routing table Tb2, the IP address of the server 180 indicated in the risk notification, and the confirmed IP address of the in-vehicle ECU 202A, and transmits the table update frame to the in-vehicle relay device 101. Note that the in-vehicle ECU 202B may transmit the table update frame to the in-vehicle relay device 101 in a standby state in which information is not being exchanged with other in-vehicle ECUs 202.

The in-vehicle relay device 101 receives the table update frame from the in-vehicle ECU 202B, and performs table update processing to update the routing table Tb2.

More specifically, in the table update processing, the in-vehicle relay device 101 performs processing for changing the relay destination of a frame whose source IP address is the IP address of the server 180 and whose destination IP address is the IP address of the in-vehicle ECU 202A in the routing table Tb2. Specifically, for example, the in-vehicle relay device 101 changes the relay destination of the frame from the in-vehicle ECU 202A to the in-vehicle ECU 202B. In other words, the in-vehicle relay device 101 causes access from the server 180 to be accepted by the in-vehicle ECU 202B instead of the in-vehicle ECU 202A.

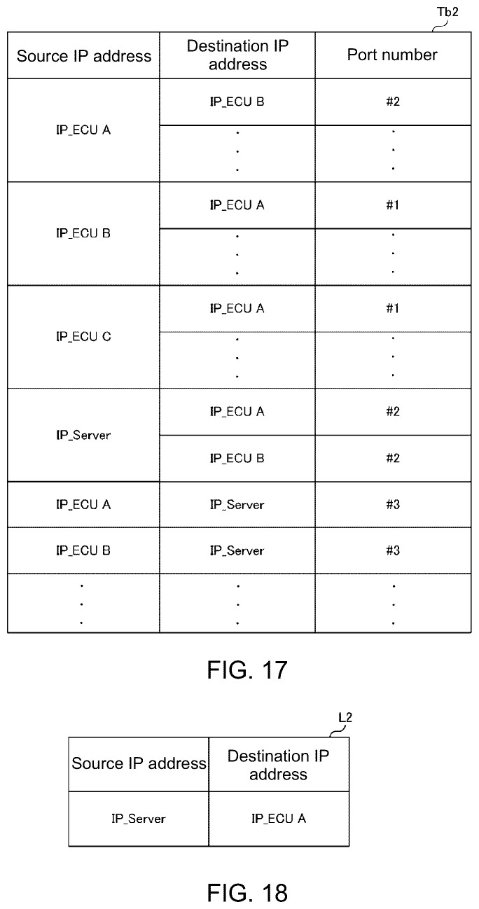

FIG. 17 is a diagram illustrating an example of the routing table after table update processing is performed by the in-vehicle relay device according to the second embodiment of the present disclosure.

As shown in FIGS. 2 and 17, specifically, for example, upon receiving the table update frame from the in-vehicle ECU 202B, the in-vehicle relay device 101 reads out the routing table Tb2 in the storage unit 62. Then, in the routing table Tb2, the in-vehicle relay device 101 identifies a frame whose source IP address is the IP address of the server 180 included in the table update frame and whose destination IP address is the IP address of the in-vehicle ECU 202A, and changes the port number corresponding to the identified frame from “#1” to “#2.”

Also, for example, upon receiving a table update frame from the in-vehicle ECU 202B, the in-vehicle relay device 101 performs list creation processing to create a management list L2 that indicates the correspondence between the source IP address included in the changed relay destination frame and the destination IP address included in the changed relay destination frame.

FIG. 18 is a diagram illustrating an example of the management list created by list creation processing performed by the in-vehicle relay device according to the second embodiment of the present disclosure.

As shown in FIG. 18, upon receiving a table update frame from the in-vehicle ECU 202B, the in-vehicle relay device 101 creates the management list L2 indicating a relay stop frame whose source IP address is the IP address “IP_Server” of the server 180 included in the table update frame and whose destination IP address is the IP address “IP_ECU A” of the in-vehicle ECU 202A included in the table update frame. The in-vehicle relay device 101 then stores the created management list L2 in the storage unit 62.

### Communication Continuation Processing

Referring again to FIG. 2, for example, after receiving a risk notification from the server 180, the in-vehicle relay device 101 further performs communication continuation processing for allowing communication to continue to be performed in the vehicle 1 by the in-vehicle ECU 202A.

More specifically, for example, as the communication continuation processing, the in-vehicle relay device 101 allows communication between the in-vehicle ECU 202A and the in-vehicle ECU 202B to continue to be performed.

Specifically, for example, the in-vehicle relay device 101 receives a risk notification from the server 180 and performs table update processing and list creation processing, and then upon receiving a frame from an in-vehicle ECU 202, reads out the routing table Tb2 and the management list L2 in the storage unit 62. The in-vehicle relay device 101 then refers to the management list L2 and checks whether or not the received frame is a relay stop frame.

If the frame received from the in-vehicle ECU 202 is a relay stop frame, the in-vehicle relay device 101 stores, in the payload of the frame, identification information indicating that the frame is addressed to the in-vehicle ECU 202A. The in-vehicle relay device 101 then refers to the routing table Tb2 and transmits the frame storing the identification information to the in-vehicle ECU 202B.

After transmitting the table update frame to the in-vehicle relay device 101, when the in-vehicle ECU 202B receives a frame from the in-vehicle relay device 101, the in-vehicle ECU 202B checks whether or not identification information is stored in the payload of the frame.

If identification information is stored in the payload of the frame from the in-vehicle relay device 101, the in-vehicle ECU 202B performs transfer processing for transmitting the frame to the in-vehicle ECU 202A via the in-vehicle relay device 101.

Specifically, for example, the in-vehicle ECU 202B changes the destination IP address of the frame that was received from the in-vehicle relay device 101 and stores the identification information, from its own IP address to the IP address of the in-vehicle ECU 202A. The in-vehicle ECU 202B then transmits the frame with the changed destination IP address to the in-vehicle relay device 101. The in-vehicle relay device 101 transmits the frame received from the in-vehicle ECU 202B to the in-vehicle ECU 202A.

The in-vehicle ECU 202A receives the frame from the in-vehicle ECU 202B via the in-vehicle relay device 101, and performs predetermined processing based on various information included in the frame.

On the other hand, if identification information is not stored in the payload of the frame from the in-vehicle relay device 101, the in-vehicle ECU 202B determines that the transfer processing does not need to be performed. The in-vehicle ECU 202B then performs predetermined processing based on various information included in the frame.

Also, for example, as the communication continuation processing, the in-vehicle relay device 101 allows communication between the in-vehicle ECU 202A and the in-vehicle ECU 202C to continue to be performed.

More specifically, for example, after receiving a risk notification from the server 180, if a frame received from an in-vehicle ECU 202 is not a relay stop frame, the in-vehicle relay device 101 refers to the routing table Tb2 and transmits the frame to the in-vehicle ECU 202 that is the destination.

Specifically, for example, after receiving a risk notification from the server 180, if a frame addressed to the in-vehicle ECU 202C from the in-vehicle ECU 202A is received, the in-vehicle relay device 101 transmits the frame to the in-vehicle ECU 202C that is the destination.

Furthermore, for example, after receiving a risk notification from the server 180, if a frame addressed to the in-vehicle ECU 202A is received from the in-vehicle ECU 202C, the in-vehicle relay device 101 transmits the frame to the in-vehicle ECU 202A that is the destination.

Transmission of Information From In-vehicle ECU 202A to Server 180 Also, for example, after receiving a risk notification from the server 180, the in-vehicle relay device 101 allows the transmission of information from the in-vehicle ECU 202A to the server 180 to continue.

More specifically, for example, after receiving a risk notification from the server 180, upon receiving a frame addressed to the server 180 from the in-vehicle ECU 202A, the in-vehicle relay device 101 transmits the frame to the server 180 that is the destination via the TCU 202C.

Note that after receiving a risk notification from the server 180, the in-vehicle relay device 101 may stop the transmission of information from the in-vehicle ECU 202A to the server 180.

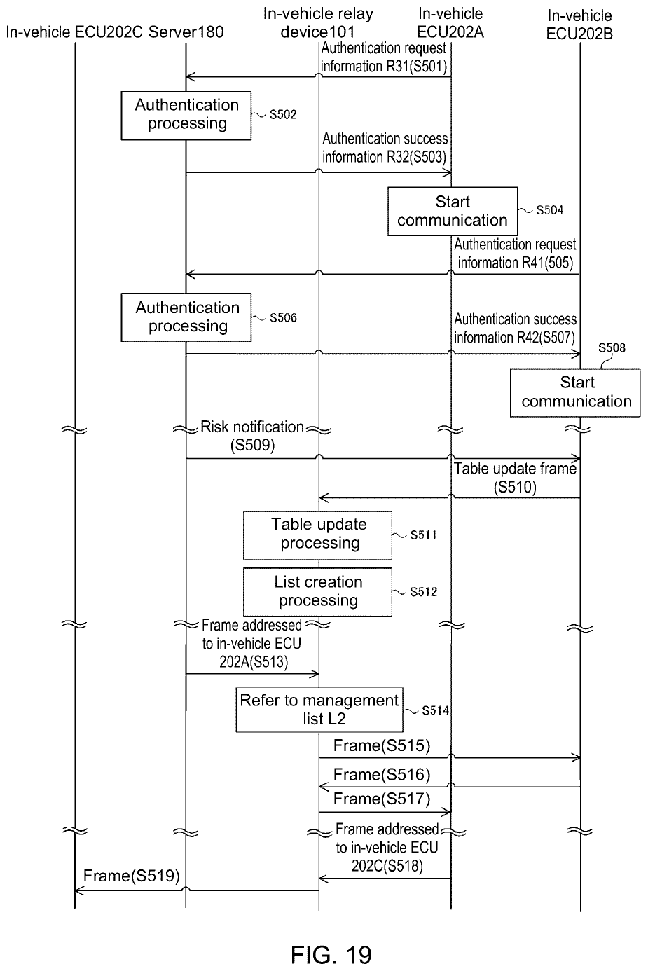

FIG. 19 is a diagram illustrating an example of a sequence of processing performed by the in-vehicle relay device, an in-vehicle ECU, and the server in the communication system according to the second embodiment of the present disclosure.

As shown in FIG. 19, first, the in-vehicle ECU 202A transmits the authentication request information R31 indicating a request for authentication and its own IP address to the server 180 via the in-vehicle relay device 101 and the TCU 202C (step S501).

Next, the server 180 receives the authentication request information R31 from the in-vehicle ECU 202A via the in-vehicle relay device 101 and the TCU 202C, and performs authentication processing for the in-vehicle ECU 202A (step S502).

Next, if authentication of the in-vehicle ECU 202A is successful, the server 180 transmits authentication success information R32 indicating successful authentication and indicating the IP address of the in-vehicle ECU 202A as the destination IP address to the in-vehicle ECU 202A via the TCU 202C and the in-vehicle relay device 101 (step S503).

Next, the in-vehicle ECU 202A receives the authentication success information R32 from the server 180 via the TCU 202C and the in-vehicle relay device 101, and starts communication with the server 180 (step S504).

Next, the in-vehicle ECU 202B transmits the authentication request information R41, which indicates a request for authentication and its own IP address, to the server 180 via the in-vehicle relay device 101 and the TCU 202C (step S505).

Next, the server 180 receives the authentication request information R41 from the in-vehicle relay device 101 via the TCU 202C, and performs authentication processing for the in-vehicle ECU 202B (step S506).

Next, if authentication of the in-vehicle ECU 202B is successful, the server 180 transmits authentication success information R42 indicating successful authentication and indicating the IP address of the in-vehicle ECU 202B as the destination IP address to the in-vehicle ECU 202B via the TCU 202C (step S507).

Next, the in-vehicle ECU 202B receives the authentication success information R42 from the server 180 via the TCU 202C and the in-vehicle relay device 101, and starts communication with the server 180 (step S508).

Next, the server 180 transmits a risk notification regarding a security risk pertaining to the in-vehicle ECU 202A, to the in-vehicle ECU 202B via the TCU 202C and the in-vehicle relay device 101. For example, as described above, the server 180 transmits an IP packet that includes the risk notification and includes its own IP address as the source IP address and the IP address of the in-vehicle ECU 202B as the destination IP address, to the in-vehicle ECU 202B via the TCU 202C and the in-vehicle relay device 101 (step S509).

Next, the in-vehicle ECU 202B transmits, to the in-vehicle relay device 101, a table update frame that includes an update notification indicating a request to update the routing table Tb2, and includes the IP address of the server 180 indicated in the risk notification and the IP address of the in-vehicle ECU 202A (step S510).

Next, the in-vehicle relay device 101 performs table update processing to update the routing table Tb2. For example, as described above, in the routing table Tb2, the in-vehicle relay device 101 identifies a frame in which the IP address of the server 180 included in the table update frame received from the in-vehicle ECU 202B is the source IP address and the IP address of the in-vehicle ECU 202A included in the table update frame is the destination IP address, and changes the port number corresponding to the identified frame to the port number that corresponds to the in-vehicle ECU 202B (step S511).

Next, the in-vehicle relay device 101 performs list creation processing to create the management list L2 indicating the changed relay destination frame. For example, as described above, the in-vehicle relay device 101 creates the management list L2 indicating a relay stop frame whose source IP address is the IP address of the server 180 and whose destination IP address is the IP address of the in-vehicle ECU 202A (step S512). Note that steps S 511 and S512 may be executed in reverse order, or may be executed in parallel.

Next, the server 180 transmits a frame addressed to the in-vehicle ECU 202A to the in-vehicle relay device 101 via the TCU 202C (step S513).

Next, the in-vehicle relay device 101 refers to the management list L2 in the storage unit 62 and confirms that the destination IP address included in the frame received from the server 180 is registered in the management list L2 (step S514).

Next, the in-vehicle relay device 101 stores, in the payload of the frame received from the server 180, identification information indicating that the frame is addressed to the in-vehicle ECU 202A, and transmits the frame to the in-vehicle ECU 202B (step S515).

Next, upon confirming that identification information is stored in the frame received from the in-vehicle relay device 101, the in-vehicle ECU 202B changes the destination IP address of the frame to the IP address of the in-vehicle ECU 202A and transmits the frame to the in-vehicle relay device 101 (step S516).

Next, the in-vehicle relay device 101 transmits the frame received from the in-vehicle ECU 202B to the in-vehicle ECU 202A (step S517).

Next, the in-vehicle ECU 202A outputs a frame addressed to the in-vehicle ECU 202C to the relay unit 52 (step S518).

Next, the in-vehicle relay device 101 transmits the frame received from the in-vehicle ECU 202A to the in-vehicle ECU 202C that is the destination (step S519).

Also, in the in-vehicle systems 301 and 302 according to embodiments of the present disclosure, the control unit 12 is configured to perform communication continuation processing to allow communication to continue to be performed in the vehicle 1 by the first functional unit 11A after receiving a risk notification from the server 180, but the present disclosure is not limited to this. The control unit 12 may be configured to stop communication performed in the vehicle 1 by the first functional unit 11A after receiving a risk notification from the server 180.

Also, as different configurations with respect to security, the in-vehicle systems 301 and 302 according to embodiments of the present disclosure have configurations in which the software used by the first functional unit 11A and the software used by the second functional unit 11B are different from each other, but the present disclosure is not limited to this. As different configurations with respect to security, the in-vehicle systems 301 and 302 may have configurations in which the hardware in the first functional unit 11A and the hardware in the second functional unit 11B are different from each other.

Furthermore, in the in-vehicle systems 301 and 302 according to embodiments of the present disclosure, the control unit 12 is configured to allow the transmission of information from the first functional unit 11A to the server 180 to be continued after receiving a risk notification regarding the first functional unit 11A from the server 180, but the present disclosure is not limited to this. The control unit 12 may be configured to stop the transmission of information from the first functional unit 11A to the server 180 after receiving a risk notification from the server 180.

The above-described embodiments are intended to be considered as examples in all respects and not restrictive. The scope of the present disclosure is indicated by the scope of the claims rather than the meaning described above, and is intended to include all changes within the meaning and scope equivalent to the scope of the claims.

The processes (functions) of the above-described embodiment are realized by a processing circuit that includes one or more processors. The processing circuit may include, in addition to the one or more processors, an integrated circuit including a combination of one or more memories, various analog circuits, and various digital circuits, for example. The one or more memories store a program (instructions) that causes the one or more processors to execute the above-described processes. The one or more processors may execute the processes in accordance with the program read from the one or more memories, or may execute the processes in accordance with a logic circuit designed in advance to execute the processes. The processors may be any of various processors suitable for control of a computer, such as a central processing unit (CPU), a graphics processing unit (GPU), a digital signal processor (DSP), a field programmable gate array (FPGA), and an application specific integrated circuit (ASIC). Note that the processors may be physically separated and execute the processes in cooperation with each other. For example, the processors may be installed in physically separated computers and execute the processes in cooperation with each other via a network such as a local area network (LAN), a wide area network (WAN), or the Internet. The program may be installed in a memory from an external server device or the like via a network, or may be distributed in a state of being stored in a recording medium such as a compact disc read only memory (CD-ROM), a digital versatile disk read only memory (DVD-ROM), or a semiconductor essential memory, and installed in the memory from the recording medium.

1. An in-vehicle system for installation in a vehicle, the in-vehicle system comprising:
a plurality of functional units, including a first functional unit and a second functional unit having different configurations with respect to security; and
a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.

2. The in-vehicle system according to claim 1, wherein the control unit is further configured to perform communication continuation processing to allow communication to continue to be performed in the vehicle by the first functional unit after reception of the risk notification from the external device.

3. The in-vehicle system according to claim 2, wherein as the communication continuation processing, the control unit allows communication to continue to be performed between the first functional unit and a functional unit other than the first functional unit and the second functional unit among the plurality of functional units.

4. The in-vehicle system according to claim 2, wherein as the communication continuation processing, the control unit allows communication to continue to be performed between the first functional unit and the second functional unit.

5. The in-vehicle system according to claim 1, wherein as the different configurations with respect to security, first software used by the first functional unit is different from second software used by the second functional unit.

6. The in-vehicle system according to claim 5,
wherein the first software provides one or more functions, including a function of performing secure communication in compliance with a first communication protocol, and
the second software provides one or more functions, including a function of performing secure communication in compliance with a second communication protocol different from the first communication protocol.

7. The in-vehicle system according to claim 5,
wherein the first software includes a first application, and
the second software includes a second application different from the first application.

8. The in-vehicle system according to claim 5,
wherein the first software includes a first OS (Operating System), and
the second software includes a second OS different from the first OS.

9. A security management method in an in-vehicle system that is for installation in a vehicle and includes a plurality of functional units, including a first functional unit and a second functional unit having different configurations with respect to security, the security management method comprising the steps of:
receiving, in a case where a state of the first functional unit and a state of the second functional unit are a normal state, a risk notification regarding a security risk pertaining to the first functional unit from an external device outside the vehicle; and
performing, in a case where the risk notification was received, substitution processing to stop access from the external device to the first functional unit and cause the access to be accepted by the second functional unit.

10. A security management program for use in an in-vehicle system that is for installation in a vehicle and includes a plurality of functional units, including a first functional unit and a second functional unit having different configurations with respect to security, the security management program causing a computer to function as:
a control unit configured to, in a case where a state of the first functional unit and a state of the second functional unit are a normal state and a risk notification regarding a security risk pertaining to the first functional unit is received from an external device outside the vehicle, perform substitution processing to stop access from the external device to the first functional unit and cause the access to be accepted by the second functional unit.
